(19) United States
(12) Patent Application Publication
(10) Pub. No.: US 2016/0365717 A1
(43) Pub. Date: Dec. 15, 2016

(54) CABLE BREAKOUT ASSEMBLIES AND MOUNTING SYSTEM THEREFOR

(71) Applicant: HUBER+SUHNER AG, Herisau (CH)

(72) Inventor: Aleksandar LAZIC, Rheineck (CH)

(73) Assignee: HUBER+SUHNER AG, CH-9100 HERISAU (CH)

(21) Appl. No.: 15/121,706

(22) PCT Filed: Jan. 6, 2015
(86) PCT No.: PCT/EP2015/050095

§ 371 Date: Aug. 25, 2016

(30) Foreign Application Priority Data
Feb. 25, 2014 (CH) 00261/14
May 14, 2014 (CH) 00731/14

(51) Int. Cl. H02G 15/117; G02B 6/44; H02G 3/04

(52) U.S. Cl. CPC H02G 15/117; H02G 3/0481; G02B 6/4472; G02B 6/4416

(57) ABSTRACT

The invention is directed to a cable breakout assembly (1) that includes a first cable gland (11) for a feeder cable (10) and several second cable glands (13) for power feeder subassemblies (12) and an enclosure (2) to which the first and the second glands (11, 13) are attached. A ground contact (9) extends across the breakout enclosure (2) of the cable breakout assembly (1). Furthermore, a mounting system (37) comprising a base plate (38) and a mounting plate (41) is foreseen to quickly mount the cable breakout assembly (1).

### BACKGROUND OF THE INVENTION

Field of the Invention

The present invention relates to a cable breakout assembly for remote radio heads (RRH) and a mounting system therefore.

Discussion of Related Art

Radio heads and other equipment for amplifying and transmitting signals from antenna towers were traditionally positioned at the base of the tower in order to facilitate the installation and maintenance thereof. Nowadays, so called remote radio heads (RRH) have become an important subsystem in base stations for mobile communication.

The remote radio head in general contains the base station's RF circuitry plus analog-to-digital/digital-to-analog converters and up/down converters. RRHs may also have operation and management processing capabilities and a standardized optical interface to connect to the rest of the base station. Relocating the transmission and amplification components to the top of the tower serves to reduce the signal losses and power requirements. Beside signal cables it is also necessary to run power cables up the tower in order to boost the individual amplifiers. In addition, it is required to provide ground connection.

Especially ground connection is often not properly solved in the cable assemblies known from the prior art.

Furthermore, RRHs are often exchanged or adopted to a new generation of mobile communication standard. With nowadays constructions each generation of antenna and thereto related RRHs require a specific number of cables which run up to the tower top. When a generation of RRH is installed, a new cable set is to be interconnected. Therefore, nowadays upgrading existing facilities to a new standard requires a lot of manual work.

From the assignee of the herein described invention several versions of environmentally sealed cable breakout assemblies are known.

W012038104 was published in 2012 in the name of the same assignee and is directed to a cable breakout assembly which includes a feeder cable, a breakout structure having a first end having a single-port cable gland through which the feeder cable extends, a central conduit which houses the sections of the feeder cable passing there through, and an opposed second end having a multi-port cable gland, whose number of ports corresponds to the number of splices of the feeder cable. The advantage of this cable breakout assembly is the simple and yet robust construction which offers a reduction of the labor work necessary for assembly and maintenance.

W013139649 was published in 2013 in the name of the same assignee. It is directed a cable breakout assembly which comprises a first gland for a feeder cable and several second glands for power feeder subassemblies. Furthermore, it comprises an enclosure with at least one carrier. The at least one carrier significantly facilitates assembly of the device.

### SUMMARY OF THE INVENTION

It is an object of the invention to provide an improved cable breakout assembly and a mounting system therefore.

An improved cable breakout assembly according to the present invention provides the ability to provide a single power feeder cable and associated assembly that can provide power to a number of individual amplifiers at the top of a radio (cell) tower. In addition, the invention offers the ability to exchange data with the RRH in a single cable. The construction according to the present invention reduces the number of cables extending up the tower and cable pulls, and reduces the number of connections required. At the top of the tower, a single feeder cable interfaces with a number of radio leads for amplifiers within an environmentally sealed container or through sealed, flexible conduits.

An embodiment of the invention is directed to a cable breakout assembly comprising a first cable gland for a feeder cable and several second cable glands for power feeder subassemblies and an enclosure (in other words a housing) to which the first and the second cable glands are attached. Furthermore a ground contact may be foreseen which extends across the enclosure of the breakout assembly. In a variation the ground contact is incorporated in a sidewall of the enclosure, e.g. in the form of an insert arranged in an opening (port). The insert may be glued into a port of the sidewall. Alternatively or in addition at least one ground contact can be incorporated in at least one cable gland. In this case the ground contact can e.g. be attached or incorporated to a carrier for the second cable glands, respectively incorporated in second breakout structure. In a variation at least one insert is foreseen to mount the breakout enclosure to a supporting structure directly or indirectly, e.g. via a mounting plate as described subsequent. Good results can be achieved if the mounting plate is made at least partially from sheet metal and or injection molded plastic material. The cable breakout assembly can interact with the mounting plate via a standardized interface. Examples thereof are described herein after in accordance with the drawings. The breakout assembly may comprise a second breakout structure for at least one optical cable. The second breakout structure can be attached to or integrated into the carrier. For space saving arrangement the second breakout structure may be arranged in the centre of the carrier radially inside with respect to the second cable glands, wherein the second glands are arranged around the second breakout structure. The carrier may comprise holding means to hold at least one second cable gland, e.g. for a power feeder pigtail assembly.

The enclosure may comprise an upper casing and a lower casing, resp. first and second casings, which in a mounted position at least partially encompass the carrier. The upper casing and the lower casing interact in length direction or in lateral direction. The breakout enclosure is at least partially filled with a casting resin.

Furthermore the invention is directed to a mounting system for a cable breakout enclosure as mentioned above and herein after. The mounting system may comprise a base plate and a mounting plate which is foreseen to be interconnected to the base plate by a standardized interface. The mounting system can be foreseen to establish a ground connection between the inside of the cable breakout assembly and earth, e.g. via the mast for the antenna. The base plate can be attached to or incorporated in the breakout enclosure. E.g. the base plate can be attached by one or several brackets and/or at least one insert to the breakout enclosure. At least one insert can be foreseen to establish ground connection. In a variation the mounting system comprises a ring shaped base plate. The ring shaped base plate may comprise a first and a second half which are circumferentially clamped around a cable breakout assembly, e.g. by bolts. If appropriate a pull strap may be attached to the base plate. Furthermore a hose may be arranged over the pull strap e.g. during mounting of the cable breakout enclosure e.g. to protect the parts of the cable breakout assembly namely the power feeder subassemblies and/or the optical subassemblies if present.

### BRIEF DESCRIPTION OF THE DRAWINGS

The herein described invention will be more fully understood from the detailed description given herein below and the accompanying drawings which should not be considered limiting to the invention described in the appended claims. The drawings are showing:

FIG. 1 is a first embodiment of a cable breakout assembly in an exploded view;

FIG. 2 is the cable breakout assembly according to FIG. 1 in a partially cut manner;

FIG. 3 is the cable breakout assembly according to FIG. 1 along with a mounting system in an exploded view;

FIG. 4 is the cable breakout assembly according to FIG. 3 in a mounted position;

FIG. 5 is a second breakout structure;

FIG. 6 is a second embodiment of a cable breakout assembly and a mounting system;

FIG. 7 is a third embodiment of a mounting system in a perspective view;

FIG. 8 is the mounting system according to FIG. 7 in an exploded manner;

FIG. 9 is a first step in the mounting process of the mounting system according to FIG. 7;

FIG. 10 is a second step in the mounting process of the mounting system according to FIG. 7.

### DETAILED DESCRIPTION OF THE INVENTION

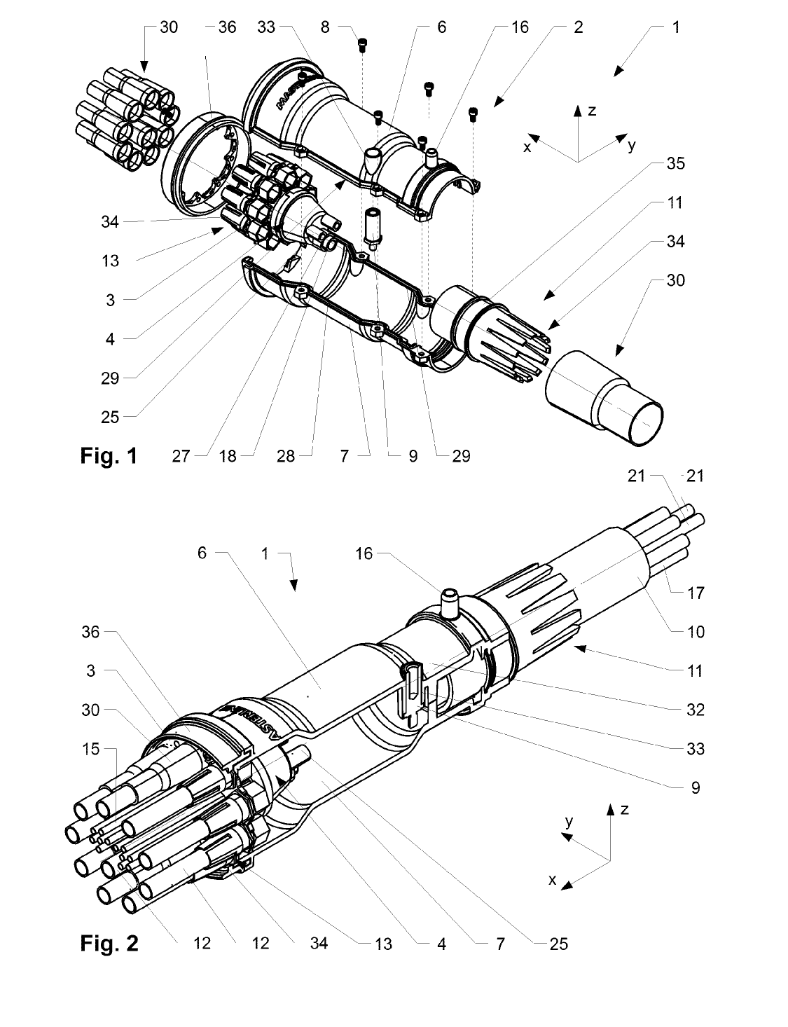

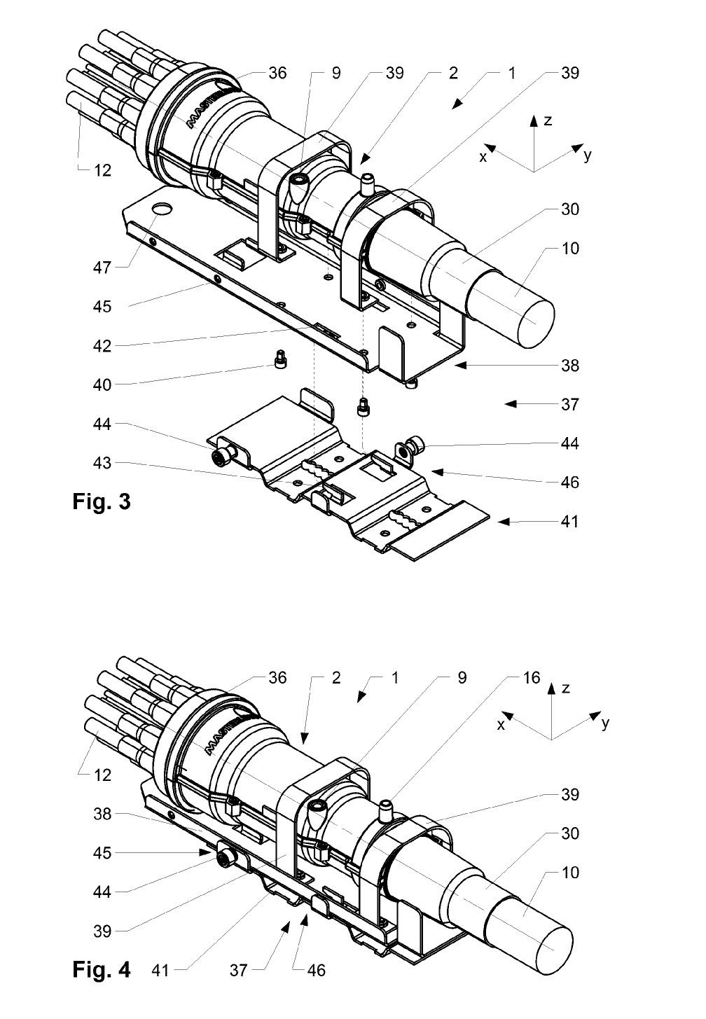

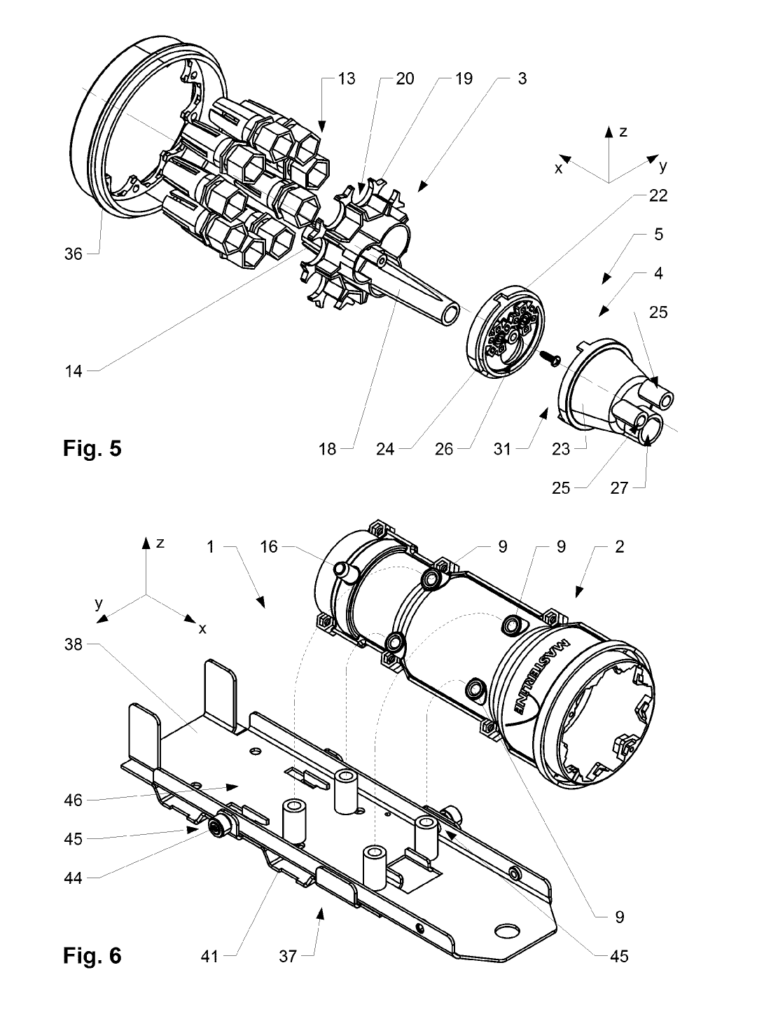

FIG. 1 is showing a first embodiment of cable breakout assembly 1 with a breakout enclosure 2 in an exploded view such that the inner structure becomes visible. FIG. 2 is showing the cable breakout assembly 1 according to FIG. 1 in an assembled manner and partially cut. FIG. 3 is showing the cable breakout assembly along with a mounting system 37 in an exploded view. FIG. 4 is showing the cable breakout assembly 1 and the mounting system 37 according to FIG. 3 in an assembled manner. FIG. 5 is showing details of a carrier 3 and a second breakout structure 5 normally arranged inside of a cable breakout assembly 1 as shown in FIGS. 1 and 2. FIG. 6 is showing a variation of the cable breakout assembly 1.

The cable breakout assembly 1 comprises a first cable gland 11 attached to a first end of the breakout enclosure 2 suitable to receiving a feeder cable 10 (see FIG. 2). On the opposite end of breakout enclosure 2, several power feeder subassemblies 12 are interconnected via second cable glands 13 to the breakout enclosure 2. The second cable glands 13 are arranged in a peripheral manner surrounding several second conduits 15 which are in a mounted position arranged in the middle. The second conduits 15 are suitable to receiving optical fibers (not shown in detail) for transmitting data e.g. to a remote radio head. The carrier 3 is forming part of the enclosure 2, respectively its outer shape. In a closed position it mates with an upper and a lower casing 6, 7 of the breakout enclosure 2. The upper casing 6 and the lower casing 7 are attached to each other by bolts 8. The assembly is schematically indicated by dotted lines. While assembling the upper and the lower casing 6, 7 a basset edge 28 which is arranged in a junction plane engage with corresponding notches 29 of the opposite part and form a secure and tight connection. The front section of the breakout enclosure 2 which comprises the upper and the lower casing 6, 7 is held together by bracket ring 36.

The present embodiment comprises an insert 9 which in the shown variation extends across a side wall 32 of the breakout enclosure 2. The insert 9 reaches into the space encompassed by the upper and the lower casing 6, 7. It acts as a ground contact and is foreseen to be interconnected to earth grounding (not shown in detail). Alternatively or in addition, a connector (not shown in detail) can be integrated in the side wall. If required, the connector can be used not only for ground contact but although for other purposes, e.g. for testing purposes. Alternatively or in addition, at least one cable gland can be foreseen to receive at least one ground contact, e.g. in the form of a cable. E.g. the at least one additional second cable gland 14 can be used as ground contact.

The insert 9 is arranged in a port 33 in a tight manner. E.g. the insert 9 is glued into the port 33. Alternatively or in addition, the insert 9 is overmolded when the side wall 32, respectively the related casing 6, 7 is made. If required, more then one insert 9 can be foreseen. Not all inserts 9 must extend into the inside of the space encompassed by the upper and the lower casing 6, 7. If appropriate, the at least one insert 9 can be used as an attachment point to affix the breakout enclosure 2 to a further device e.g. a base plate 38 as schematically indicated in FIG. 6 (wherein only the breakout enclosure 2 of a cable breakout assembly 1 is visible).

In the shown variation, the enclosure 2 comprises a socket with a filling opening 16 to fill in casting resin to fill the interior of the enclosure 2 at least partially. The casting resin is to protect the inside of enclosure against environmental influences. If required, a further opening may be foreseen for venting of the device.

Each of the power feeder subassemblies 12 comprises at least one wire (not shown in detail) for the supply of electrical energy to an interconnected device, e.g. a remote radio head (RRH), etc.

The carrier 3 and the second cable glands 13 are shown along with the second breakout structure 5 in FIG. 5. The carrier 3 here comprises fingers 19 arranged in a radial direction and designed to receive and hold the second cable glands 13. The second cable glands 13 can be inserted in a radial direction in a recess 20 formed by two adjacent fingers 19. The cable glands 11, 13 comprise several flexible fins 34 which protrude from a bottom ring 35 by which the cable glands 11, 13 can be affixed directly or indirectly to the breakout enclosure 2 and/or the carrier 3. The fins 34 are designed such that they can easily adapt to different diameters of a cables 10, 12. Afterwards, a heat shrink tube 30 is arranged on the fins and appropriate glue (not shown in detail) is arranged between the fins and the cable to be affixed forming a reliable connection. The cable glands 11, 13 act as tension relieves for the attached feeder cable 10 and power feeder subassemblies 12.

As visible in FIG. 1, in the shown variation nine second cable glands 13 are arranged coaxial with respect to each other surrounding the second breakout structure 5 the second cable glands 13 are evenly distributed on a circle. To increase the number of second cable glands 13 the shown embodiment comprises at least one additional second cable gland 14, which is arranged radially inside of the second cable glands 13. As best visible in FIG. 5, the at least one addition second cable 14 is attached to, respectively integrated into the carrier 3. At the rear end of the carrier 3 the additional second cable gland 14 leads into a tubular extension 18. The front and the rear part 22, 23 forming the housing 4 of the second breakout structure each comprise a lead through 26, 27 across which the tubular extension 18 of the carrier 3 extends in a mounted position. If appropriate, the carrier 3 can form an integral part of the housing 4. The special design of the carrier 3 and the second breakout structure 5 can be incorporated in other breakout enclosures. It is therefore considered as a separate invention and can be subject of a divisional patent application.

A feeder cable 10 normally has a hybrid setup comprising wires 17 for transmitting power and data cables, e.g. in the form of optical fibers grouped in one or several bundles arranged in one or several first conduits 21. To separate, respectively split-up the optical fibers into several second conduits 15 the second breakout structure 5 comprises a housing 4 comprises a front part 22 and a rear part 23 which can be assembled in x-direction. In the shown embodiment, the second conduits 15 are attached to the front part 22 of the housing 4 by epoxy resin (not shown in detail). The front part 22 of the housing 4 comprises at least one front opening 24, into which the second conduits 15 can be inserted, respectively affixed e.g. by epoxy resin. In a mounted position the openings 25, respectively the second conduits 15 for the optical fibers (not shown in detail) are arranged adjacent to the tubular extension 18, respectively to the at least one additional second cable gland 14. The at least one first conduit 21 which in a mounted position is arranged inside of the feeder cable 10 next to several wires 17 is foreseen to receive several optical fibers (not shown in detail). The at least one first conduit 21 leads into the housing 4 of the second breakout structure 5 by a corresponding rear opening 25 in the rear part 23 of the housing 4. The at least one first conduit 21 is normally attached to the rear part of the housing 4 by glue, e.g. epoxy resin. The front and the rear part 22, 23 of the housing 4 encompass a compartment 31 in which the optical fibers (not shown in detail) which enter the compartment 31 from the at least one first conduit 21 are separated from the bundles and/or distributed into the second conduits 15. The second conduits 15 can receive one or more optical fibers.

FIGS. 3 and 4 are showing a mounting system 37 by which a breakout enclosure 2 of a cable breakout assembly 1 as e.g. shown in the FIGS. 1 and 2 can be quickly mounted to a specific location, e.g. at the top of a mast. The mounting system 37 as described herein can be used in connection with other breakout assemblies not shown and described herein. Therefore it can be subject of a separate patent application.

The mounting system according to the invention comprises a base plate 38 to which the breakout enclosure 2 is attached and a mounting plate 41 which interacts with the base plate 38 by a standardized interface. The standardized interface 46 can be foreseen to establish ground contact. In the shown embodiment the breakout enclosure 2 is attached to the base plate 38 by two strap like brackets 39 and thereto corresponding bolts 40. The direction of assembly is schematically indicated by dotted lines. Furthermore, a mounting plate 41 is present which comprises second holding means 43 which are foreseen to connect to first holding means 42 interconnected or forming part of the base plate 38. The base plate 37 and the mounting plate 41 of the shown variation are made from sheet metal. Depending on the field of application they can alternatively or in addition be made at least partially from injection molded plastic. In the shown embodiment, the first holding means 42 in the form of recesses and the second holding means 43 are in the form of hooks. Furthermore, first locking means 44 are present which interact in a mounted position with second locking means 45 and thereby interconnect the base plate and the mounting plate. In the shown variation, the first locking means 44 are incorporated in the form of locking screws and the second locking means 45 in the form of locking wholes into which the locking screws 44 can be screwed in. Depending on the field of application, other holding and locking means can be foreseen. Furthermore, it is possible to incorporate the locking means in the holding means. Alternatively or in addition, the holding and/or the locking means can be incorporated in or directly attached to the breakout enclosure 2, i.e. in the upper and/or the lower casing 6, 7. Thereby, the base plate 38 can be avoided. If required the base plate 38 can comprise a lug 47 as shown in FIG. 3. A rope (not shown in detail) can be attached to the lug 47 such that the cable breakout assembly can be pulled up to the top of a mast of a base station for mobile communication. The lug 47 is arranged such that the base plate 38 can easily be attached to a mounting plate 41.

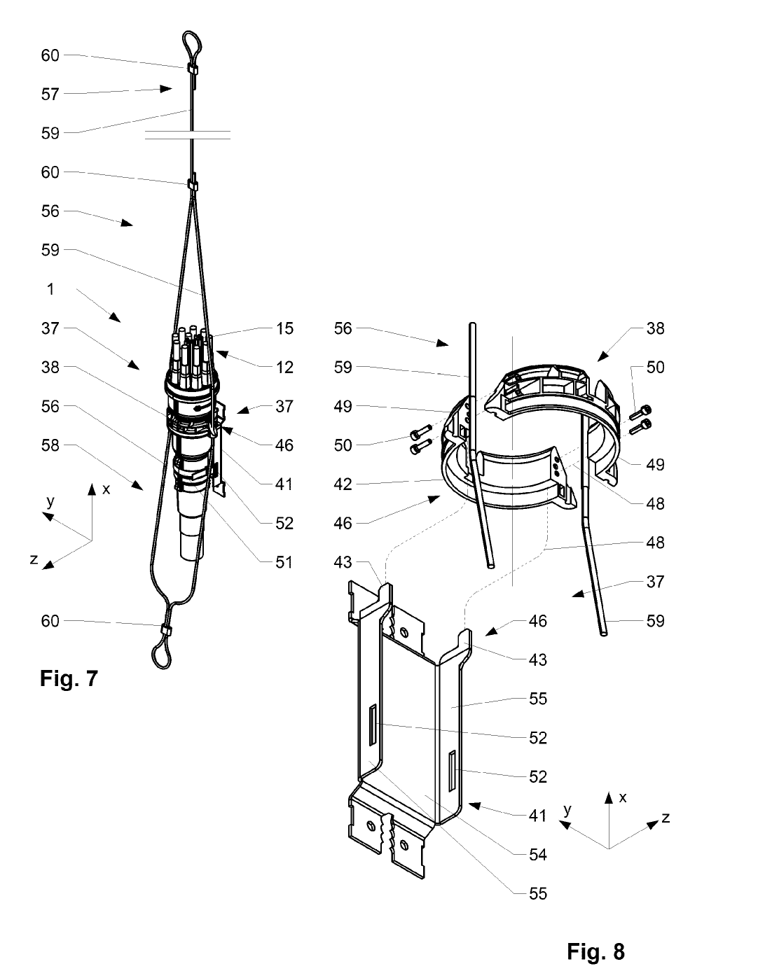

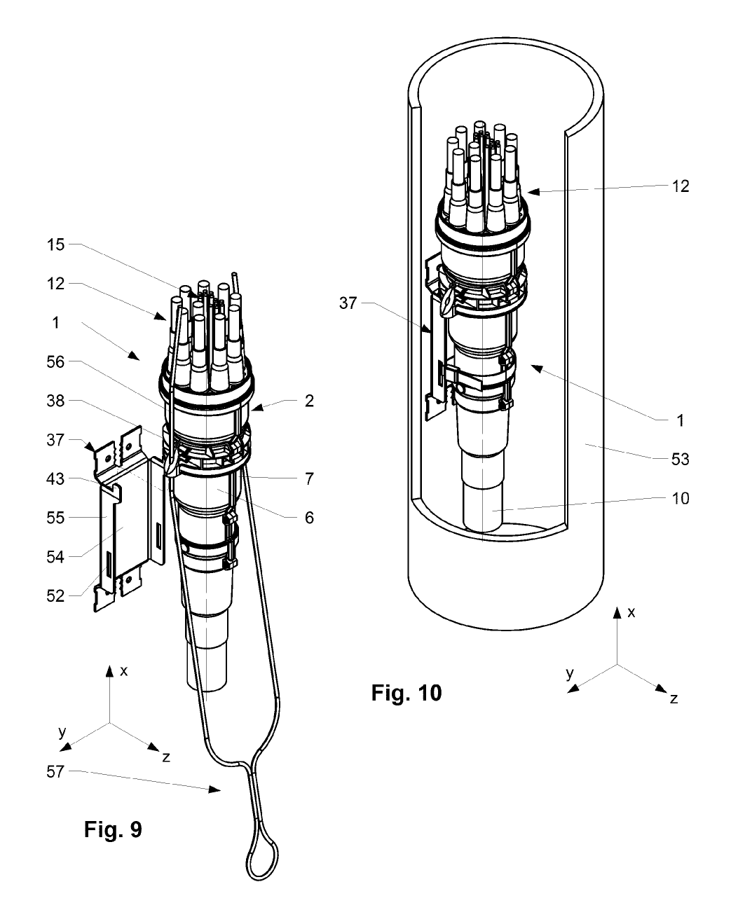

FIGS. 7 through 10 show a third embodiment of a mounting system 37 for a cable breakout assembly 1 in several views. In FIG. 7, the mounting system 37 is shown along with the cable breakout assembly 1 in a perspective view from a right hand side. FIG. 8 shows the mounting system 37 without a cable breakout assembly in a perspective view in an exploded manner. Assembly and mounting are indicated by dotted lines 48. FIG. 9 shows how the here ring shaped base plate 38 is attached to the mounting plate 41 via a standardized interface 46. The mounting plate 41 is attached e.g. to a mast (inside or outside) or a wall or any other device (not shown). FIG. 10 schematically shows how the cable breakout assembly 1 is attached via the mounting system 37 to the inside of a tubular mast 53.

In the shown variation the ring shaped base plate 38 comprises a first and a second half 49 which can be clamped to a breakout enclosure 2 of a cable breakout assembly 1 by bolts 50 (other fastening means are possible). If appropriate, the ring shaped base plate 38 can be made in one piece which is then slid onto the staggered breakout enclosure 2 from the lower end. The ring shaped base plate 38 comprises a holding rim 42, which protrudes from the lower end and acts as first holding means 42. The rim 42 is foreseen to hook into the hooks 43 arranged at the mounting plate 41 and which acts as second holding means. The mounting plate 41 has an in principle U-shaped cross section comprising a rear wall 54 and two lateral flanges 55. The mounting plate 41 of the shown variation is preferably made from sheet metal by bending and/or stamping. Alternatively or in addition, the base plate can be made from plastic material. When attached to the mounting plate 41, the cable breakout assembly 1 is in addition secured to the mounting plate 41 by a clamp 51, which runs through two lugs 52 arranged at the mounting plate 41. Other securing means can be foreseen as an alternative or in addition.

To pull the cable breakout assembly up outside or inside along a mast, a pull strap 56 is attached to the ring shaped base plate 38. The pull strap 56 has an upper and a lower end 57, 58. In the shown variation, the pull strap 56 is tightly clamped between the two halves 49 of the ring shaped base plate 38. Depending on the field of application, the pull strap 56 can be used to attach the cable breakout assembly 1 to a mast alternatively or in addition to the mounting plate 41. Furthermore, it is possible to integrate the first holding means (i.e. the rim 42) into the breakout enclosure 2. Alternatively or in addition, the pull strap may be attached directly to the breakout enclosure 2. One advantage of the herein shown variation is the slim design which allows to arrange the cable breakout enclosure 1 inside of a mast 53. When the pull strap 56 is not used anymore, e.g. after the base plate 38 is attached to the mounting plate 41, the pull strap 56 can be removed by cutting it of either at both ends or only at one end 57, 58.

As best visible in FIG. 7, the upper end 57 of the pull strap 56 has a certain length. In a first section, the pull strap consists of two cables 59, in a second section the pull strap continues as a single cable 59 only. The cables 59 are in the shown variation attached by e.g. press-fit bushings 60. For mounting of the cable breakout assembly the power feeder subassemblies 12 and if present the second conduits 15 can be attached in an elongated manner in length direction to the upper end 57 of the pull strap 56. Furthermore, a hose (not shown in detail) can be arranged over the upper end 57 of the pull strap 56 protecting the power feeder subassemblies 12 and the second conduits 15 during mounting of the cable breakout assembly 1.

One advantage of the shown mounting system is that the mounting plate 41 needs not to be exchanged when a new breakout assembly is fitted, i.e. the mounting plate 41, can be attached to an antenna mast before the cable breakout assembly 1 is attached.

Rather, the words used in the specification are words of description rather than limitation, and it is understood that various changes may be made without departing from the spirit and scope of the invention.

1. A cable breakout assembly (1) comprising
a. a first cable gland (11) for a feeder cable (10);
b. a plurality of second cable (13) glands for power feeder subassemblies (12);
c. an enclosure (2) to which the first and the second cable glands (11, 13) are attached; and
d. a ground contact (9) extending across the enclosure (2) of the cable breakout assembly (1).

2. The cable breakout assembly (1) according to claim 1 wherein a ground contact (9) is incorporated in a sidewall of the enclosure (2).

3. The cable breakout assembly (1) according to claim 2, wherein the ground contact comprises an insert (9).

4. The cable breakout assembly (1) according to claim 3, wherein the insert (9) is glued into a port (33) of the sidewall.

5. The cable breakout assembly (1) according to claim 1, wherein a ground contact is incorporated in at least one cable gland.

6. The cable breakout assembly (1) according to claim 1, wherein at least one insert mounts the breakout enclosure (2) to a supporting structure (37).

7. The cable breakout assembly (1) according to claim 1, wherein the cable breakout assembly (1) comprises a second breakout structure (5) for at least one optical cable.

8. The cable breakout assembly (1) according to claim 7, wherein the second breakout structure (5) is attached to or integrated into a carrier (3). (Currently amended) The cable breakout assembly (1) according to claim 7, wherein the second breakout structure (5) is arranged in the center of the carrier (3).

10. The cable breakout assembly (1) according to claim 1, wherein the second cable glands (13) are arranged around the second breakout structure (3).

11. The cable breakout assembly (1) according to claim 1, wherein the carrier (3) comprises holding means to hold at least one second cable gland.

12. The cable breakout assembly (1) according to claim 1, wherein the enclosure (2) comprises a first casing and a second casing (6, 7), which in a mounted position at least partially encompass the carrier (3).

13. The cable breakout assembly (1) according to claim 12, wherein the first casing and the second casing (6, 7) interact in length direction or in lateral direction.

14. The cable breakout assembly (1) according to claim 1, wherein the breakout enclosure (2) is at least partially filled with a casting resin.

15. Mounting system (37) for a cable breakout assembly (1) according to claim 1, further comprising a base plate (38) and a mounting plate (41) interconnected to the base plate (38) by a standardized interface (46).

16. The mounting system (37) according to claim 15, wherein the mounting system (37) establishes a ground connection between the inside of the cable breakout assembly (1) and earth.

17. The mounting system (37) according to claim 15, wherein the base plate (38) is incorporated in the breakout enclosure (2).

18. The mounting system (37) according to claim 15, wherein the base plate (38) is attached by an insert to the breakout enclosure (2).

19. The mounting system (37) according to claim 15, wherein the base plate (38) is ring shaped.

20. The mounting system (37) according to claim 19, wherein the base plate (38) comprises a first and a second half (49).

21. The mounting system (37) according to claim 19, wherein the ring shaped base plate (38) comprises a holding rim (42), which protrudes from the lower end and comprises a first holding means (42).

22. The mounting system (37) according to claim 15, wherein a pull strap (56) is attached to the base plate (38).

23. The mounting system (37) according to claim 22, wherein a hose is arranged over the pull strap (56) to protect a cable breakout assembly (1) at least partially.
